(19) United States
(12) Patent Application Publication
(10) Pub. No.: US 2001/0009732 A1
(43) Pub. Date: Jul. 26, 2001

(54) Fuel cell battery for liquid fuels

(75) Inventor: Alexander Schuler, Weisslingen (CH)

Correspondence Address: J. Georg Seka, Townsend and Townsend and Crew LLP, 8th Fl., Two Embarcadero Center, San Francisco, CA, 94111, US

(73) Assignee: Sulzer Hexis AG

(21) Appl. No.: 09/764,781

(22) Filed: Jan. 17, 2001

(30) Foreign Application Priority Data
Jan. 25, 2000 (EP) 00810065.3

(51) Int. Cl. H01M 8/06

(52) U.S. Cl. 429/19; 429/26

(57) ABSTRACT

The fuel cell battery (1) for liquid fuels has the following components: a cell stack (2) which is arranged along an axis (2a) and within a periphery (2b); a distributor passage (21) on the stack axis (2a) via which a reformed fuel gas can be fed in into cells (20) of the stack (2); afterburner chambers (22) at the stack periphery (2b); furthermore an auxiliary burner (3) for a start-up operation. A reaction device (3) is in connection with the cell stack and is provided for the treatment of the liquid fuel by reforming with partial oxidation to form a fuel gas which contains CO and H₂. A heat exchanger system (4) is integrated into the reaction device, by means of which, in a current delivering operation of the battery (1)—using hot exhaust gas from the afterburning chambers—the liquid fuel can be vaporized and a gaseous oxygen carrier can be heated up. Via an infeed point (6) which is part of the heat exchanger system, vaporized fuel can be brought into contact with a heated up oxygen carrier for forming the reformed fuel gas. This fuel gas can be fed in from the reaction device into the distributor passage of the cell stack.

The invention relates to a fuel cell battery for liquid fuels in accordance with the preamble of claim 1, to a method for the operation and to a use of the battery.

In a device with high temperature fuel cells, which is for example known from EP-A-0 654 838 (=P.6612), electrical energy is generated from a methane-containing fuel gas and air. In a first step the fuel gas is catalytically treated (reformed) together with water vapour H₂O and with an input of heat at about 800° C. to form a fuel gas containing carbon monoxide CO and hydrogen H₂. Current delivering processes can be carried out in the fuel cells at operating temperatures of 850 to 900° C. in a second step with this reformed fuel gas. Heat given off, which arises in the current delivering processes and in an afterburning, is used in the treatment process, the reforming. It is also possible to reform a liquid fuel, which is for example a hydrocarbon CₙHₘ, with n>5 and m=2n+2, or a mixture of such hydrocarbons, to form a fuel gas containing CO and H₂ and to use the latter for the operation of the known fuel cells. The fuel is vaporized prior to the reforming, with the named heat given off also advantageously being used. The use of a liquid fuel for the operation of a fuel cell battery is possible in a stationary plant; it is particularly advantageous in a mobile plant, for example in an automobile, in which the fuel can be carried along in a tank. For a mobile use it is necessary, for economic reasons, that the H₂O, which is required for the reforming and which in known plants must be made available as demineralized water, not be required.

The object of the invention is to create a fuel cell battery for liquid fuels which can be used in a mobile plant and in which no water is required for the treatment of a fuel gas. This object is satisfied by a battery which is defined in claim 1.

The fuel cell battery for liquid fuels has the following components: a cell stack which is arranged along an axis and within a periphery; a distributor passage on the stack axis via which a reformed fuel gas can be fed in into cells of the stack; afterburner chambers at the stack periphery; furthermore an auxiliary burner for a start-up operation. A reaction device stands in connection or communication with the cell stack and is provided for the treatment of the liquid fuel by reforming with partial oxidation to a fuel gas which contains CO and H₂. A heat exchanger system is integrated into the reaction device by means of which, in a current delivering operation of the battery—using hot exhaust gas from the afterburning chambers—the liquid fuel can be vaporized and a gaseous oxygen carrier can be heated up. Via an infeed point which is part of the heat exchanger system, vaporized fuel can be brought into contact with heated up oxygen carrier for forming the reformed fuel gas. This fuel gas can be fed in from the reaction device into the distributor passage of the cell stack.

Subordinate claims 2 to 9 relate to advantageous embodiments of the fuel cell battery in accordance with the invention. A method and possibilities of using the battery in accordance with the invention are the subject of claims 10 and 11 respectively.

In the following the invention will be explained with reference to the drawings. Shown are:

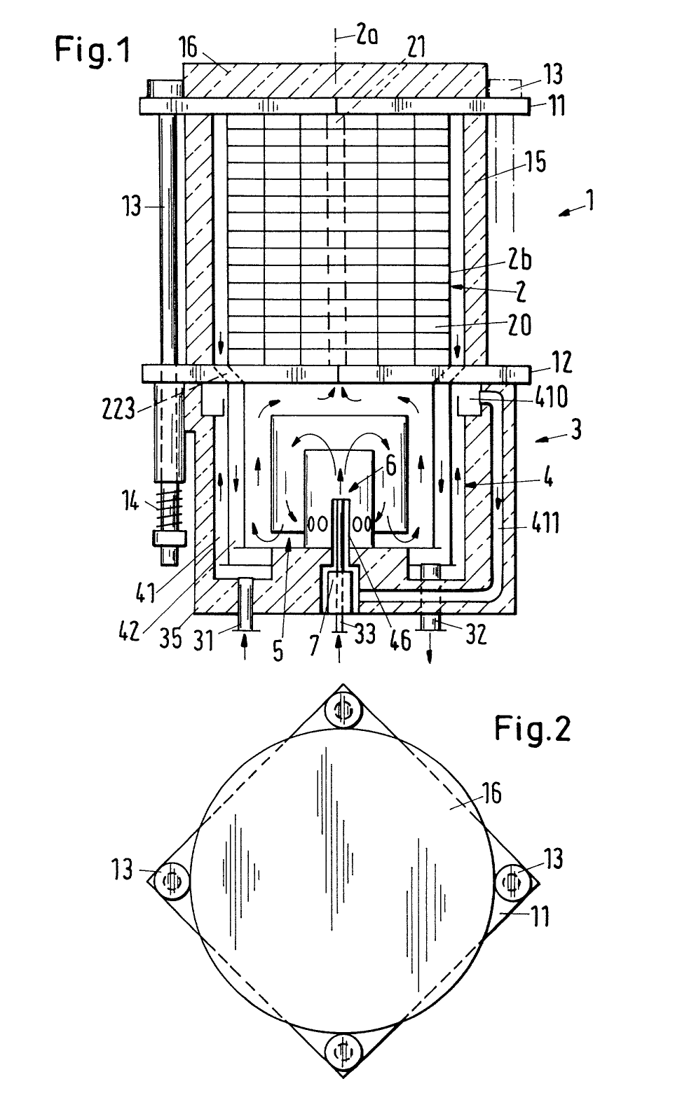

FIG. 1 a first exemplary embodiment of the fuel cell battery in accordance with the invention,

FIG. 2 a plan view of the battery of FIG. 1,

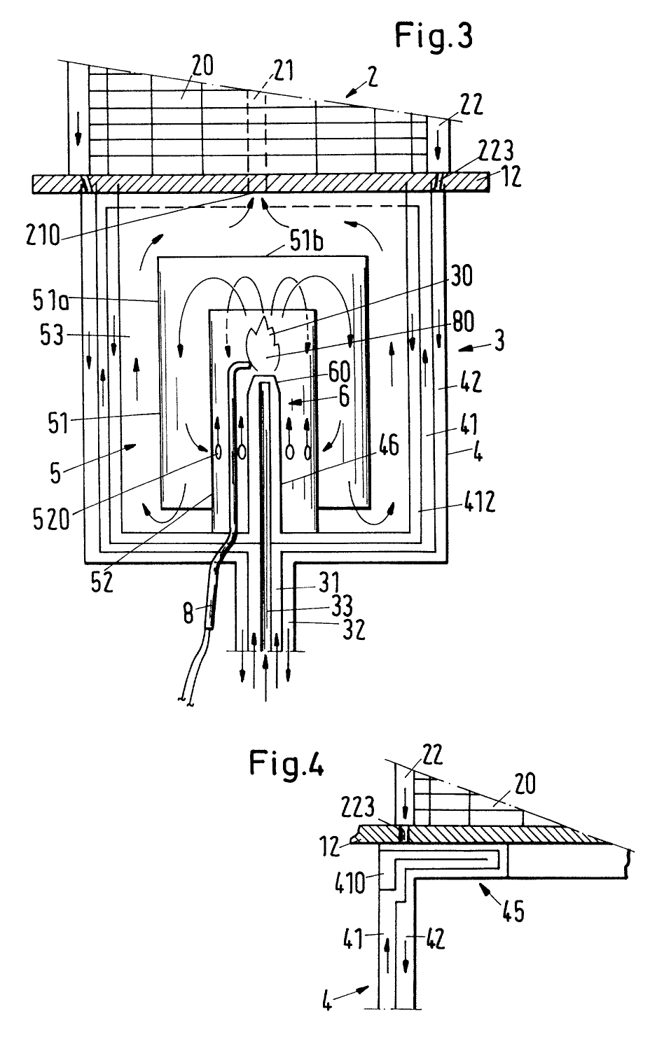

FIG. 3 a second exemplary embodiment,

FIG. 4 a detail pertaining to a third exemplary embodiment,

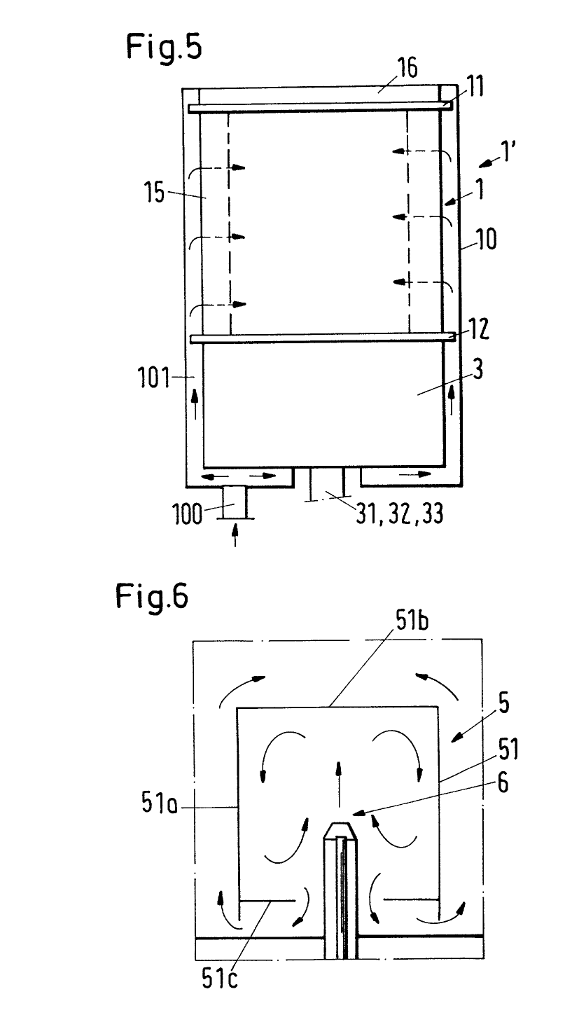

FIG. 5 a schematic illustration of a plant with the fuel cell battery in accordance with the invention and

FIG. 6 an alternative solution for inbuilt elements for carrying out the partial oxidation.

For a fuel cell battery 1 in accordance with the invention, which can be used for a current generation with liquid fuels, a first exemplary embodiment is illustrated in FIG. 1; a plan view of this battery 1 is shown in FIG. 2. The battery 1 comprises fuel cells 20 which form a stack 2 along an axis 2a and within a periphery 2b. A distributor passage 21, via which a reformed fuel gas can be fed in into the cells 20, lies on the stack axis 2a. A sleeve 15 contains non-illustrated air supply means via which a gaseous oxygen carrier can be fed in into the cells 20. The fuel, which can not be completely used in the current delivering processes, is completely burned with the oxygen carrier, which has passed the cells 20, in one or more afterburner chambers 22 at the stack periphery 2b.

The cell stack 2 is arranged between plates 11 and 12, which can be formed as electrical poles of the battery 1. The required pressing force between elements of the cells 20, which are stacked one on the other, is provided for by tie bars 13 and springs 14. The tie bars 13 are arranged in an edge region of the battery 1, where the temperature is relatively low. A thermal insulation 16 largely covers over the plate 11.

A reaction device 3 is arranged aligned with the stack axis 2a and lying in contact at the cell stack 2. In this reaction device 3 a reformation with partial oxidation is carried out for the treatment of the liquid fuel. In this a fuel gas containing CO and H₂ arises without a supplying of water being required for this reformation.

A heat exchanger system 4 which is located inside a heat insulating sleeve 35 is integrated into the reaction device 3. During the current delivering operation of the battery the hot exhaust gas from the afterburner chamber 22 can be used, on the one hand for vaporizing the liquid fuel and on the other hand for heating up a gaseous oxygen carrier. Vaporized fuel can be brought into contact with the heated up oxygen carrier via an infeed point 6, which is a part of the heat exchanger system 4, so that the reforming with partial oxidation can take place. After the forming of the reformed fuel gas the latter is fed in into the distributor passage 21 of the cell stack 2 from the reaction device 3.

An indirect heat exchange between the exhaust gas and the oxygen carrier takes place in the heat exchanger system 4, with these two media being conducted in counter-flow through two ring-gap-shaped sub-chambers 41 and 42. The sub-chambers 41 and 42 are largely arranged in prolongation of the stack periphery 2b. The oxygen carrier enters via an input stub into the heat exchanger system 4, from there into the sub-chamber 41, from there into a common passage 410 and from there via a connection line 411 into the infeed point 6. The exhaust gas emerges from the afterburner chamber 22 via bores 223 in the plate 12 into the sub-chamber 42 and leaves the heat exchanger system 4 via an outlet stub 32.

In a central region of the reaction device 3 coaxial infeed tubes for the fuel and the preheated oxygen carrier form the infeed point 6, with the infeed tubes being formed by a central tube 33 for the fuel and an external tube 46 for the oxygen carrier. These infeed tubes 33, 46 are designed such that a sufficient amount of heat is transferred in the current delivering operation from the preheated oxygen carrier into the fuel so that the latter vaporizes.

The reaction device 3 is equipped with inbuilt elements 5 and a sufficiently large volume so that dwell times for the carrying out of the partial oxidation result for which the predominant proportion of the carbon contained in the fuel reacts to form CO or CO₂. The purpose of the inbuilt elements 5 is a good mixing of the reaction partners and a high recirculation, so that a uniform reaction density develops. Through this the temperature distribution likewise becomes uniform and a soot formation is minimized.

An electrical heater 7 which can be used for a vaporization of the fuel during starting up of the battery operation is preferably provided at the supply line 33 for the liquid fuel. During the starting up the reaction device 3 can be used as an auxiliary burner, with the oxygen carrier being supplied in excess so that the fuel is completely burned. The hot combustion gases can then be used for the heating up of the cells 20.

FIG. 3 shows a second exemplary embodiment which has substantially the same inbuilt elements 5 as the first exemplary embodiment. These inbuilt elements 5 are formed by two coaxial cylinders 51 and 52 which are arranged around the infeed point 6. The outer cylinder 51 has a jacket surface 51a and an end surface 51b which are closed and which cause a deflection of the gas flows which emerge from the infeed point 6. The other cylinder 52, which is arranged inside the first cylinder 51, consists of a jacket surface with apertures 520. The named gas flows have momentum by means of which a loop-like circulation flow in the first cylinder 51 is driven.

An ignition device 7 with ignition electrodes 70 is arranged at the infeed point 6. With this a combustion can be ignited during the start-up of the battery or the reaction can be ignited during the starting of the partial oxidation, which is indicated as a flame 80.

The heat exchanger system 4 differs from that of the first exemplary embodiment: The flow of the hot exhaust gases out of the afterburner chamber 22 is conducted in an outer, ring-gap-shaped sub-chamber 42. Concentrically to a tube 32, through which the exhaust gas is conducted off out of the reaction device 3, the oxygen carrier enters through a tube 31 into the heat exchanger system 4, where it is conducted in counter-flow to the exhaust gas through an inner, ring-gap-shaped sub-chamber 41. The heated up oxygen carrier is conducted via a second ring-gap-shaped sub-chamber 412 to the tube 46 of the infeed point 6. The outlet end 60 of the tube 46 is formed as a nozzle, so that sufficient momentum is transferred for driving the circulation flow in the reaction chamber.

FIG. 4 shows a detail pertaining to a third exemplary embodiment which relates to the heat exchanger system 4 and which is a variant of the heat exchanger system 4 of the first exemplary embodiment: At the infeed bores 223 for the exhaust gas, radial gap chambers 45, via which a heat exchange takes place from the exhaust gas to the oxygen carrier, are arranged following the ring-gap chambers 41 (oxygen carrier) and 42 (exhaust gas).

The battery 1 in accordance with the invention is provided for an electrical power of more than 1 kW and less than 5 kW. The inbuilt elements 5 are designed in their order of magnitude such that the inner cylinder 52 has a diameter of 5 cm and the outer cylinder 51 has a diameter of 10 cm. A ring gap 53 with a gap width of 2 cm is provided around the outer cylinder 51 through which the reformed fuel gas can flow to an input point 210 of the distributor passage 21.

In the reforming with partial oxidation a ratio for the proportions of the oxygen carrier and the fuel is chosen for which at least 50%, preferably 80-90% of the carbon which is contained in the fuel is oxidized to CO. The rest is oxidized to CO₂.

FIG. 5 shows a schematic illustration of a plant 1′ with the fuel cell battery 1 in accordance with the invention which is arranged in a container 10. At the periphery of the reaction device 3, which is formed by the non-illustrated heat exchanger system 4, there is provided a ring-gap-shaped sub-chamber 101 through which air or another oxygen carrier, which is required for the reaction, can be conducted. The air is fed in via a stub 100 of the container 10. After flowing through the sub-chamber 101 it arrives via the heat insulating enclosure 15 into the cells 20 of the stack 2. Through this infeed of fresh air the surface of the battery 1 remains at a low temperature.

In FIG. 6 an alternative solution for the inbuilt elements 5 for carrying out the partial oxidation is illustrated. In comparison with the inbuilt elements 5 of the embodiment in accordance with FIGS. 1 to 3, the inner cylinder 52 is lacking here. Instead a ring-shaped deflection wall 51c which acts deflectingly on the gas flow is arranged at the lower end surface of the cylinder 51, so that a loop flow develops, which is indicated by arrows.

The fuel cell battery 1 in accordance with the invention can be used in a stationary or in a mobile plant.

1. Fuel cell battery (1) for liquid fuels, comprising a cell stack (2) which is arranged along an axis (2a) and within a periphery (2b), a distributor passage (21) on the stack axis (2a) via which a reformed fuel gas can be fed in into cells (20) of the stack (2), afterburner chambers (22) at the stack periphery (2b) and an auxiliary burner (3) for a start-up operation,
characterized in that
a reaction device (3), which stands in connection with the cell stack, is provided for the treatment of the liquid fuel by reforming with partial oxidation to form a fuel gas which contains CO and H₂, with a heat exchanger system (4) being integrated into the reaction device, by means of which, in a current delivering operation of the battery—using hot exhaust gas from the afterburning chambers—the liquid fuel can be vaporized and a gaseous oxygen carrier can be heated up; in that an infeed point (6) is part of the heat exchanger system; in that vaporized fuel can be brought together with heated up oxygen carrier for forming the reformed fuel gas via this infeed point; and in that this fuel gas can be fed in from the reaction device into the distributor passage of the cell stack.

2. Fuel cell battery in accordance with claim 1, characterized in that the reaction device (3) is arranged aligned with the stack axis (2a) and contacting the cell stack (2); and in that it can be used as an auxiliary burner.

3. Fuel cell battery in accordance with claim 1 or claim 2, characterized in that an indirect heat exchange between the exhaust gas and the oxygen carrier takes place in the heat exchanger system (4) during the current delivering operation; and in that the exhaust gas and the oxygen carrier can be conducted to this heat exchange through at least two ring-shaped sub-chambers (41, 42) which are largely arranged in a prolongation of the stack periphery (2b).

4. Fuel cell battery in accordance with any one of the claims 1 to 3, characterized in that coaxial supply tubes (33, 46) in a central region of the reaction device (3) form the infeed point (6) for the fuel and the preheated oxygen carrier, with it being possible in particular to feed in the fuel through a central supply tube (33); and in that the supply tubes are designed in such a manner that, in the current delivering operation, a sufficient amount of heat for the vaporisation of the fuel can be taken up from the preheated oxygen carrier.

5. Fuel cell battery in accordance with any one of the claims 1 to 4, characterized in that the reaction device (3) is equipped with inbuilt elements (5) for the formation of a loop flow and has a sufficiently large volume that dwell times for the carrying out of the partial oxidation result, for which the predominant portion of the carbon which is contained in the fuel reacts to CO or CO₂.

6. Fuel cell battery in accordance with claim 5, characterized in that the inbuilt elements (5) are coaxial cylinders (51, 52) which are arranged about the infeed point (6); in that the one cylinder (51) has a jacket surface as well as an end surface (51a, 51b) which are closed and which cause a deflection of the gas flows which emerge from the infeed point; and in that the other cylinder (52), which is arranged inside the first cylinder, consists of a jacket surface with apertures (520), as a result of which the named gas flows cause a loop-like circulation flow in the first cylinder (51), with it being possible to replace the inner cylinder (52) by a ring-shaped wall (51c) which is arranged at the lower edge of the jacket surface (51a) of the first cylinder and in the inner region of this edge.

7. Fuel cell battery in accordance with claim 6, characterized in that it is provided for an electrical power of more than 1 kW and less than 5 kW; and in that the inbuilt elements are designed in their order of magnitude such that the inner cylinder (52) has a diameter of 5 cm and the outer cylinder (51) has a diameter of 10 cm; and in that a ring gap (53) with a gap width of 2 cm through which the reformed fuel gas can flow to an input point (210) of the distributor passage (21) is provided about the outer cylinder.

8. Fuel cell battery in accordance with any one of the claims 1 to 7, characterized in that an electrical heating device (7) is preferably provided at a supply line (33) for the liquid fuel and can be used in a starting up of the current delivering operation for a vaporization of the fuel; and in that an ignition electrode (8, 80) is arranged at the infeed point (6), by means of which a combustion in the auxiliary burner or the partial oxidation for starting up can be ignited.

9. Fuel cell battery in accordance with any one of the claims 1 to 8, characterized in that a ring-shaped sub-chamber (101) is provided at the periphery of the heat exchanger system (4) through which air, or another oxygen carrier which is required for the reactions, can be conducted.

10. Method for the operation of a fuel cell battery (1) in accordance with any one of the claims 1 to 9, characterized in that a ratio is provided for the reaction between the oxygen carrier and the fuel for their proportions for which at least 50%, preferably 80-90% of the carbon which is contained in the fuel is oxidized to CO—the rest to CO₂.

11. Use of a fuel cell battery (1) in accordance with any one of the claims 1 to 9 in a stationary or in a mobile plant, with a hydrocarbon CₙHₘ, with n>5 and for example m=2n+2, or a mixture of such hydrocarbons, being used as a fuel.
